(19) United States
(12) Patent Application Publication
(10) Pub. No.: US 2016/0310939 A1
(43) Pub. Date: Oct. 27, 2016

(54) SINGLE USE MEDICAL TEST PACKAGING

(71) Applicants: Ted Titmus, Mission Viejo, CA (US); William Pat Price, Henderson, NV (US)

(72) Inventors: Ted Titmus, Mission Viejo, CA (US); William Pat Price, Henderson, NV (US)

(21) Appl. No.: 14/694,860

(22) Filed: Apr. 23, 2015

(51) Int. Cl. B01L 3/00

(52) U.S. Cl. CPC B01L 3/505; B01L 2200/141; B01L 2300/0887; B01L 2300/0636; B01L 2300/123

(57) ABSTRACT

The present disclosure provides systems and devices for maintaining the reagent integrity of a diagnostic test device. In one aspect, the system provides a single-use medical test package that can be implemented to allow for sterile and secure maintenance of a diagnostic test device to ensure the integrity of the device and to provide accurate analyte analysis. The medical test package can be implemented with one or more flexible sheets as a protective layer. The medical test package can also include a flexible supporting sheet on which the diagnostic test device can be secured. Gas may also be used to inflate and pressurize the medical test package in order to prevent deterioration and degradation of the reagents on the test pad.

### FIELD OF THE INVENTION

The present disclosure generally relates to diagnostic assay materials. More specifically, the technology relates to medical test packaging for storing diagnostic test devices in a secure and sterile environment.

### BACKGROUND

A medical diagnostic device may be used in a variety of applications. For example, there is a continuous need for medical diagnostic devices in medical practice, research, and diagnostic procedures to conduct rapid, accurate, and qualitative or quantitative determinations of biological substances which are present in biological fluids at low concentrations.

Diagnostic devices, such as diagnostic test strips, must be maintained in an environment that is free of contaminates until the moment before the device is used. By design, the devices are often highly absorbent. However, premature absorption of moisture or other contaminants may alter test results. A known industry practice for keeping the diagnostic devices dry is to store a plurality of such devices in a capped container or vial. The container may contain a desiccant to keep the devices dry. When eventually used, a doctor or other testing personnel, including a patient, will remove the cap from the container, extract a diagnostic device, and contact the diagnostic device to the sample. A disadvantage of this technique is that all of the diagnostic devices within the vial must be used within a relatively short time after the vial is first opened or they cannot be reliably used. Because of the exposure to the ambient atmosphere upon opening, there is a risk that the test strips will absorb enough moisture to render them ineffective in this amount of time despite the presence of the desiccant in the container. It is therefore desirable to provide a single-use medical test package with the ability to resist water absorption, reflect heat, and provide a stable environment for the diagnostic device in order to protect it against physical damage. These and other objects and features of the invention will be apparent from the following description, drawings, and claims.

### SUMMARY OF THE INVENTION

One embodiment of the subject matter described in this disclosure can be implemented in a system for maintaining the reagent integrity of a diagnostic test device, wherein the system includes a diagnostic test device, one or more test pads, an upper flexible sheet, a lower flexible sheet, and a flexible supporting sheet. At least one test pad may have at least one test reagent thereon. The upper and lower flexible sheets can be joined to form a hermetically sealed cavity and the supporting flexible sheet can be inside the cavity and attached to the joint formed by the upper and lower sheets, and the supporting sheet can be configured to substantially bisect the cavity. In some embodiments, the cavity can be at least partially inflated with one or more gases and the diagnostic test device can be removably in contact with the support sheet. In some embodiments, inner walls of the inflated cavity do not contact the diagnostic test device.

In some embodiments, the upper flexible sheet, the lower flexible sheet, and the flexible supporting sheet can be made of different material. In some embodiments, the upper flexible sheet, the lower flexible sheet, and the flexible supporting sheet can be made of the same material. In some embodiments, the upper flexible sheet and the lower flexible sheet are opaque. The upper flexible sheet and the lower flexible sheet can be metal foil, surgical aluminum foil, medical aluminum foil, or plastic.

In some embodiments, there is a gas used to partially inflate the cavity. The gas can be an inert gas, including nitrogen or argon. The gas can be medical air, ambient air, or carbon dioxide. The gas can also substantially inflate the cavity or it can fully inflate the cavity.

In some embodiments, the joint formed with the upper flexible sheet, the lower flexible sheet, and the supporting sheet is formed with ultrasound welding. In other embodiments the joint can be formed with adhesives or with resistive welding.

In some embodiments, the diagnostic test device is attached to the flexible supporting sheet with a mechanical retaining device that is in turn attached to the flexible supporting sheet. In other embodiments the diagnostic test device is attached to the flexible supporting sheet with low tack adhesive.

Another embodiment of the subject matter described in this disclosure can be implemented in a system for maintaining the reagent integrity of a diagnostic test device, wherein the system includes a diagnostic test device, wherein the test device has one or more test pads wherein at least one test pad has at least one test reagent thereon, an outer top flexible sheet, an outer bottom flexible sheet, an inner top flexible sheet, an inner bottom flexible sheet, and a flexible supporting sheet. The inner top and bottom sheets can be joined at a joint to form a hermetically sealed inner cavity with outer edges. The supporting flexible sheet can be encapsulated by the inner cavity and attached to the joint formed by the inner top and bottom sheets. The supporting sheet can be configured to substantially bisect the inner cavity. The outer top and bottom sheets can be formed at a different joint as the inner top and bottom sheets or at the same joint as the inner top and bottom sheets. The outer top and bottom sheets can be joined together with the edges of the inner cavity forming an outer cavity that contains the inner cavity, and the outer cavity can be at least partially inflated with one or more gases. The atmosphere of the inner cavity may be substantially a vacuum or the cavity is at least partially inflated with one or more gases. The diagnostic test device can be removably in contact with the support sheet. In some embodiments, the inner walls of the inflated inner cavity do not contact the diagnostic test device. In some embodiments, the inner walls of the inflated inner cavity do contact the diagnostic test device.

All of the flexible sheets can be made of the same material or made of different material. The outer top flexible sheet and the outer bottom flexible sheet can be opaque. The outer top flexible sheet and the outer bottom flexible sheet can be metal foil, surgical aluminum foil, medical aluminum foil, or plastic. Both cavities can be partially filled with a gas. The outer cavity can be at least partially filled with a gas and the inner cavity can have at least a partial vacuum as an atmosphere. The gas in both cavities can be the same or different. The gas can be an inert gas including argon. The gas can be nitrogen, ambient air, medical air, or carbon dioxide.

In some embodiments of the system, the outer cavity can be substantially fully inflated. In some embodiments, both cavities can be substantially fully inflated. In some embodiments, the outer cavity can be substantially fully inflated and the atmosphere of the inner cavity can be substantially a vacuum. In some embodiments, the outer cavity is substantially fully inflated and the inner cavity is partially inflated.

In some embodiments, the diagnostic test device is attached to the flexible supporting sheet with a mechanical retaining device that is in turn attached to the flexible supporting sheet. In other embodiments the diagnostic test device is attached to the flexible supporting sheet with low tack adhesive.

In some embodiments, the system can further include a third top flexible sheet and third bottom flexible sheet, wherein the third top and bottom sheets can be attached to the joint formed by the inside and outside flexible sheets and further form a third cavity, and the third cavity can encapsulate the inner and outer cavities. The material of all of the flexible sheets can be the same or different. The material for the third top and bottom flexible sheets can be opaque. The third cavity can be at least partially inflated with a gas. The third cavity can be substantially inflated with a gas. The atmosphere in the third cavity can be substantially a vacuum. One or more gases can be used to pressurize the third cavity. The gas can be nitrogen, argon, ambient air, medical air, or carbon dioxide.

Another embodiment of the subject matter described in this disclosure can be implemented in a system for maintaining the reagent integrity of a diagnostic test device, wherein the system includes a bottom member that is a substantially rigid tub-shaped container with an opening, a top substantially flexible sealing member, a diagnostic test device, and one or more pressurized gases. The sealing member can be removably attached to the bottom member such that it forms a hermetically sealed cavity, and the cavity can contain the diagnostic test device and the one or more pressurized gases.

The bottom member can be made of plastic. The sealing member can be a metallic foil. The sealing member can be attached to the bottom member by ultrasonic welding, by resistive welding, or by adhesives. The diagnostic test device can be removably mechanically attached to the bottom member such that the reagents on the test device do not come in contact with the inner surfaces of the cavity.

In some embodiments, the gas used to inflate the cavity or cavities can be an inert gas. The gas can be nitrogen, argon, medical air, ambient air, and/or carbon dioxide. The one or more gases can substantially fully inflate the cavity or cavities.

The joints of the systems disclosed can be formed with ultrasound welding, with adhesives, or by resistive welding. The diagnostic test device can attached to the flexible supporting sheet with low tack adhesive or with a mechanical retaining device that is in turn attached to the flexible supporting layer. The joints forming multiple cavities can be formed by the same method or different methods.

### BRIEF DESCRIPTION OF THE DRAWINGS

FIG. 1A is a perspective view of one embodiment of a single-layer medical test package.

FIG. 1B is a layered view of one embodiment of a single-layer medical test package.

FIG. 1C is a cross-sectional view of one embodiment of a single-layer medical test package.

FIG. 1D is a cross-sectional view of one embodiment of a single-layer medical test package.

FIG. 2A is a layered view of one embodiment of a double-layer medical test package.

FIG. 2B is a cross-sectional view of one embodiment of a double-layer medical test package.

FIG. 2C is a cross-sectional view of one embodiment of a double-layer medical test package.

FIG. 3A is a layered view of one embodiment of a double-layer medical test package.

FIG. 3B is a cross-sectional view of one embodiment of a double-layer medical test package.

FIG. 4A is a layered view of one embodiment of a tub-like medical test package.

FIG. 4B is a cross-sectional view of one embodiment of a tub-like medical test package.

FIG. 5A is a layered view of one embodiment of a tub-like medical test package.

FIG. 5B is a cross-sectional view of one embodiment of a tub-like medical test package.

### DETAILED DESCRIPTION

The present application relates to U.S. patent application Ser. No. ______, filed ______ entitled “DIAGNOSTIC TEST STRIPS WITH MULTIPLE LAMINATED LAYERS CONTAINING ONE OR MORE REAGENT-CARRYING PADS IN ONE OR MORE LAYERS”, Attorney Docket Number TTUSA.005A2, U.S. patent application Ser. No. ______, filed ______ entitled “MECHANICAL ATTACHMENT OF TEST PADS TO A DIAGNOSTIC TEST STRIP”, Attorney Docket Number TTUSA.006A2, U.S. patent application Ser. No. ______, filed ______ entitled “MECHANICAL ATTACHMENT OF TEST PADS TO A DIAGNOSTIC TEST DEVICE”, Attorney Docket Number TTUSA.007A2, U.S. patent application Ser. No. ______, filed ______ entitled “DIAGNOSTIC TEST STRIP WITH SELF-ATTACHING TEST PADS AND METHODS OF USE THEREFORE”, Attorney Docket Number TTUSA.008A2, U.S. patent application Ser. No. ______, filed ______ entitled “DIAGNOSTIC TEST STRIPS WITH FLASH MEMORY DEVICES AND METHODS OF USE THEREFORE”, Attorney Docket Number TTUSA.009A2, U.S. patent application Ser. No. ______, filed ______ entitled “DIAGNOSTIC TEST STRIP FOR ORAL SAMPLES AND METHOD OF USE THEREFORE”, Attorney Docket Number TTUSA.010A2, U.S. patent application Ser. No. ______, filed ______ entitled “DIAGNOSTIC TEST STRIPS HAVING ONE OR MORE TEST PAD LAYERS AND METHOD OF USE THEREFORE, Attorney Docket Number TTUSA.011A2, U.S. patent application Ser. No. ______, filed ______ entitled “DIAGNOSTIC TEST STRIPS FOR DETECTION OF PAST OR PRESENT INFECTION OF VARIOUS STRAINS OF HEPATITIS” Attorney Docket Number TTUSA.013A2, and U.S. patent application Ser. No. ______, filed ______ entitled “DIAGNOSTIC TEST STRIPS FOR DETECTION OF PRE-SPECIFIED BLOOD ALCOHOL LEVEL” Attorney Docket Number TTUSA.014A2, all of whom have the inventors Ted Titmus and William Pat Price, all of which are filed herewith this even date, all of the disclosures of which are hereby expressly incorporated by reference in their entirety and are hereby expressly made a portion of this application.

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. Descriptions of unnecessary parts or elements may be omitted for clarity and conciseness, and like reference numerals refer to like elements throughout. In the drawings, the size and thickness of layers and regions may be exaggerated for clarity and convenience. An apparatus, system or method according to some of the described embodiments can have several aspects, no single one of which necessarily is solely responsible for the desirable attributes of the apparatus, system or method. After considering this discussion, and particularly after reading the section entitled “Detailed Description” one will understand how illustrated features serve to explain certain principles of the present disclosure.

Some embodiments of the technology disclosed herein provide for a medical test package containing a diagnostic test device, such as a diagnostic test strip, having a test pad. The test pad may contain test reagents and/or signaling reagents. Various features of the embodiments enable both trained and untrained personnel to reliably detect the presence of one or more analytes in a liquid sample. Features of the embodiments disclosed herein allow for maintaining the diagnostic test device in a cool, clean, secure, sterile, non-reactive environment in order to maintain the integrity of the test reagents until immediately prior to use. The embodiments disclosed also allow the diagnostic test device to be stored for long periods and transported without deterioration or damage to the diagnostic test device or the test pads and reagents contained thereon. Consequently, the embodiments disclosed are ideal for use in both prescription and over-the-counter assay test kits requiring secure, sterile and accurate diagnostic testing systems in a convenient single-use package that can withstand extreme physical conditions and extreme heat.

Embodiments of the invention can be used to detect any analyte which has heretofore been assayed using known immunoassay procedures, or known to be detectable by such procedures. Furthermore, it is envisioned that known methods can be modified as needed to afford suitable test reagents and/or signaling reagents that will detect analytes that are similar to analytes that have been previously detected using known procedures.

Some embodiments of the invention provide a system for detecting one or more analytes in a sample (e.g. a patient, patient's physiological fluids, soil, water, air, food, or chemical sample), the system including an embodiment of a diagnostic test device which is used to contact a sample such that the sample comes in physical contact with one or more test pads of the diagnostic test device. The system may be used to detect analytes from any of the following samples: physiological fluids such as mucus, blood, serum, blood plasma, lymph, puss, urine, feces, cerebral spinal fluid, ocular lens liquid, ascites, semen, sputum, and saliva; synthetic chemicals; water; air; food; and soil. In some circumstances, it may be advantageous to contact the diagnostic test device with one or more signaling reagents such that the one or more signaling reagents contacts the one or more test pads. For example, the analyte of interest and/or sample analyzed may require the contact of the one or more signaling reagents with the one or more test pads such that signal generation is facilitated and/or enhanced.

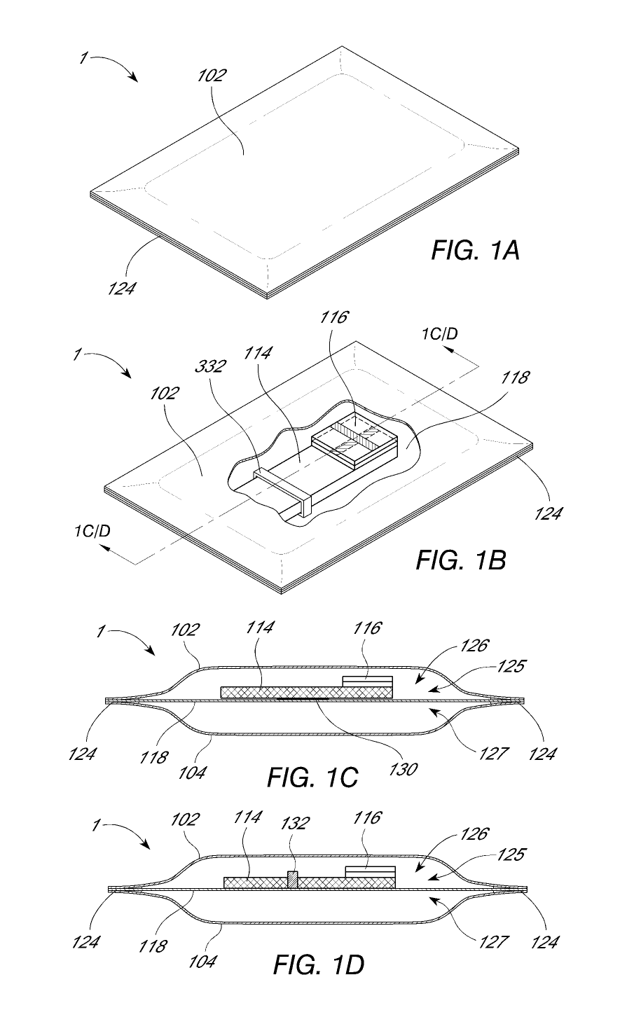

FIGS. 1A-1D provide views of an embodiment of a single-layer medical test package 1. The medical test package 1 is comprised of an upper flexible sheet 102, a lower flexible sheet 104, and a flexible supporting sheet 118. The medical test package 1 may include a diagnostic test device 114. The diagnostic test device 114 may be fitted with a test pad 116. The test pad 116 may contain one or more reagents that are capable of detecting one or more analytes.

The upper flexible sheet 102 and the lower flexible sheet 104 may be joined at a joint 124. The joint 124 acts to hermetically seal the medical test package 1 around its perimeter. By joining the upper flexible sheet 102 and the lower flexible sheet 104 at the joint 124, a cavity 126 is formed between the upper and lower flexible sheets 102 and 104. The joint 124 between the upper and lower flexible sheets 102 and 104 may be formed with ultrasound welding, with adhesives, or with resistive welding.

The flexible supporting sheet 118 may be placed inside the cavity 126 between the upper and lower flexible sheets 102 and 104 in a manner substantially coplanar with the upper and lower flexible sheets 102 and 104. The flexible supporting sheet 118 may be secured at the joint 124 with the upper and lower flexible sheets 102 and 104, thereby bisecting the cavity 126 into an upper section 125 and a lower section 127. The diagnostic test device 114 may rest on the flexible supporting sheet 118 in the upper section 125 of the cavity 126.

As seen in FIG. 1C, in one embodiment, the diagnostic test device 114 may be secured to the top of the flexible supporting sheet 118 by, for example, a low-tack adhesive 130. In one embodiment, as seen in FIG. 1D, the diagnostic test device 114 may be secured to the top of the flexible supporting sheet 118 by a retaining device 132, which crosses over the diagnostic test device 114 and attaches to the top of the flexible supporting member 118 on one or both sides of the diagnostic test device 114. The retaining device 132 may secure the diagnostic test device 114 in place by providing pressure to force it against the flexible supporting sheet 118, or it may secure the diagnostic test device 114 by being attached to the diagnostic test device 114 itself in addition to being attached to the flexible supporting member 118. Securement of the diagnostic test device 114 in this manner ensures that the test pad 116 is not damaged in transport or storage of the medical test package 1. Securement in this manner also keeps the medical test device 114 from moving around and physically contacting the upper flexible sheet 102 where it could inadvertently be contaminated by the materials or residue on the upper flexible sheet 102.

In the process of forming the joint 124 and sealing the medical test package 1, the cavity 126 may be partially or fully inflated with one or more gases. Inflating the cavity 126 with a gas creates a gap between the diagnostic test device 114 and the upper flexible sheet 102. The existence of the gap prevents the top of the diagnostic test device 114, and thus, the test pad 116, from making physical contact with the inside of the upper flexible sheet 102. In the event that the upper flexible sheet contains substances that are detrimental to the reagents on the test pad 116, preventing the test pad 116 from contacting the upper flexible sheet 102 is useful in maintaining the integrity of the reagent or reagents contained in the test pad 116.

The gas used to inflate the cavity may be an inert gas such as nitrogen, argon, or medical air. An inert gas may be used to prevent reactivity of the test pad 116 with the gas, thereby avoiding contamination and deterioration of the reagents on the test pad 116. In some embodiments, oxygen and other reactive gases may be displaced in the medical test package 1 as the cavity 126 is filled with the inert gas. Use of an inert gas also prevents moisture contamination that may occur if ambient air used, as the test pad 116 may be contaminated by water molecules present in ambient air. If reactivity of the reagent on the test pad 116 is not a concern, other gases, such as ambient air and carbon dioxide, may also be used to inflate the medical test package 1.

The upper and lower flexible sheets 102 and 104 and the flexible supporting sheet 118 may be made of metal foil, aluminum foil, medical aluminum foil or plastic. The flexible sheets may contain a reflective coating on the outside of the sheets in order to reflect radiant heat away from the test pad 116 in order to maintain a cool environment for the diagnostic test device 114 and maintain the integrity of the reagents used on the test pad 116. The flexible sheets may also be opaque or translucent. Each of the flexible sheets may be made of different materials or the same materials. For identification of the medical test package 1 (identifying, for example, the reagent used on the test pad 116 or the manufacture date), a label may be affixed to the upper or lower flexible sheet 102 and 104 or an identifying label may be printed directly on the upper or lower flexible sheet 102 and 104.

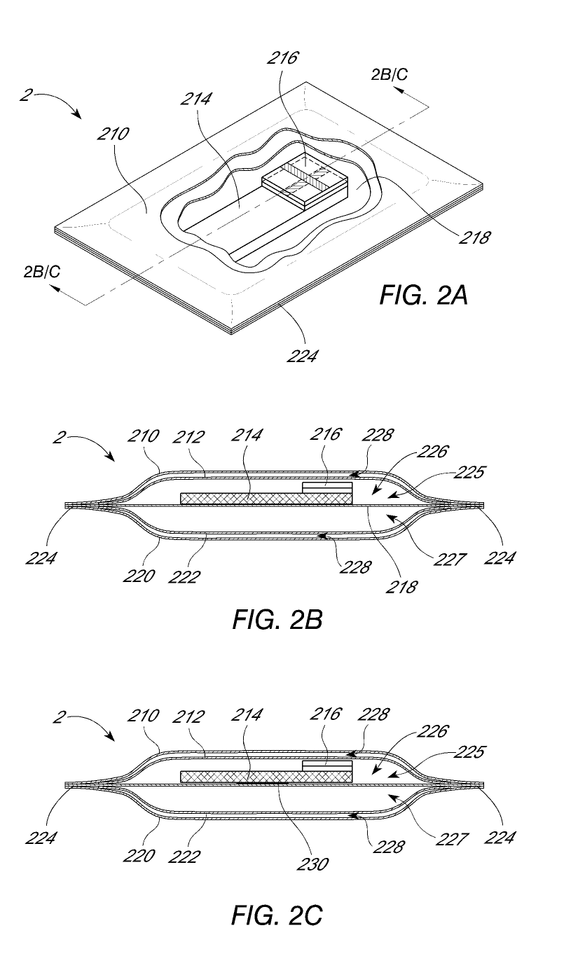

FIGS. 2A-2C show an embodiment of a double-layer medical test package 2. The medical test package 2 is comprised of an outer top flexible sheet 210, an inner top flexible sheet 212, an outer bottom flexible sheet 220, an inner bottom flexible sheet 222, and a flexible supporting sheet 218. The medical test package 2 may include a diagnostic test device 214. The diagnostic test device 214 may be fitted with a test pad 216. The test pad 216 may contain one or more reagents that are capable of detecting one or more analytes.

The inner top and bottom flexible sheets 212 and 222 may be joined at joint 224. The joint 224 acts to hermetically seal the medical test package 2 around its perimeter. By joining the inner top and bottom flexible sheets 212 and 222, an inner cavity 226 is formed. The outer top flexible sheet 210 and outer bottom flexible sheet 220 may also be joined together at the joint 224 forming the perimeter of the medical test package 2. The outer top flexible sheet 210 is fitted over the inner top flexible sheet 212 and the outer bottom flexible sheet 220 is fitted over the inner bottom flexible sheet 222 in such a manner that an outer cavity 228 is formed between the inner and outer flexible sheets on the top and bottom of the medical test package 2.

The flexible supporting sheet 218 may be placed inside the inner cavity 226 between the inner top flexible sheet 212 and inner bottom flexible sheet 222 in a manner substantially coplanar with the inner top flexible sheet 212 and inner bottom flexible sheet 222. The flexible supporting sheet 218 may be secured at the joint 224 with the inner top flexible sheet 212 and inner bottom flexible sheet 222, thereby bisecting the inner cavity 226 into an upper section 225 and a lower section 227. The diagnostic test device 214 may rest on the flexible supporting sheet 218 in the upper section 225 of the inner cavity 226. As seen in FIG. 2C, in one embodiment, the diagnostic test device 214 may be secured to the top of the flexible supporting sheet 218 by, for example, a low-tack adhesive 230. Securement of the medical test device 214 in this manner ensures that the test pad 216 is not damaged in transport or storage of the medical test package 2. Securement in this manner, along with inflation of the inner cavity 226, also keeps the medical test device 214 from moving around and keeps the test pad 216 from physically contacting the inner top flexible sheet 222 where it could inadvertently be contaminated by any contaminants or residue on the inner top flexible sheet 222.

In the process of forming the joint 224 and sealing the medical test package 2, the inner cavity 226 may be partially or fully inflated with one or more gases. Inflating the inner cavity 226 with a gas creates a gap between the diagnostic test device 214 and the inner top flexible sheet 212. The existence of the gap prevents the top of the diagnostic test device 214, and thus, the test pad 216, from making physical contact with the inside of the inner top flexible sheet 212. Preventing the test pad 216 from contacting the inner top flexible sheet 212 is beneficial in maintaining the integrity of the reagent or reagents contained in the test pad 216.

The outer cavity 228 may also be inflated may also be partially of fully inflated with one or more gases. The existence of the outer cavity 228 provides a potential added advantage to the medical test package 2 in the form of increased protection from damage during transport or deterioration during long-term storage. For example, the outsides of both layers may be coated with reflective coating to additional protection from heat and sunlight. The additional layer also may be beneficial in protecting the medical test package from inadvertent puncture or breakage prior to the intended time of use. If the outside layer is inadvertently broken, the inside layer may still provide the needed secure and sterile environment to ensure an accurate reading by the diagnostic test device 214 when it is applied to the sample.

The inner and outer flexible sheets 212, 222 and 210, 220 and the flexible supporting sheet 218 may be made of metal foil, aluminum foil, medical aluminum foil or plastic. The outer flexible sheets 210, 220 may contain a reflective coating on the outside of the sheets in order to reflect radiant heat away from the test pad 216 in order to maintain a cool environment for the diagnostic test device 214 and to maintain the integrity of the reagents used on the test pad 216. The flexible sheets may be opaque or translucent. Each of the flexible sheets may be made of different materials or the same materials. For identification of the medical test package 2, a label may be affixed to the outer flexible sheets 210 and 220 or an identifying label may be printed directly on the flexible sheets.

The gas used to inflate the inner and outer cavities may be an inert gas such as nitrogen, argon, or medical air. An inert gas may be used to prevent reactivity of the test pad 216 with the gas, thereby avoiding contamination and deterioration of the reagents on the test pad 216. In some embodiments, oxygen and other reactive gases may be displaced in the medical test package 2 as the cavity 126 is filled with the inert gas. Use of an inert gas also prevents moisture contamination that may occur if ambient air used, as the test pad 216 may be contaminated by water molecules present in ambient air. If reactivity of the reagent on the test pad 216 is not a concern, other gases, such as ambient air and carbon dioxide, may also be used to inflate the medical test package 2.

In another embodiment of the medical test package 2, a third flexible sheet is provided on the top and bottom of the medical test package 2 in order to create a third cavity for additional protection of the diagnostic test device 214 and test pad 216. The third cavity may be also partially or substantially inflated with a gas, either the same gas or a different gas that is used in the two other cavities.

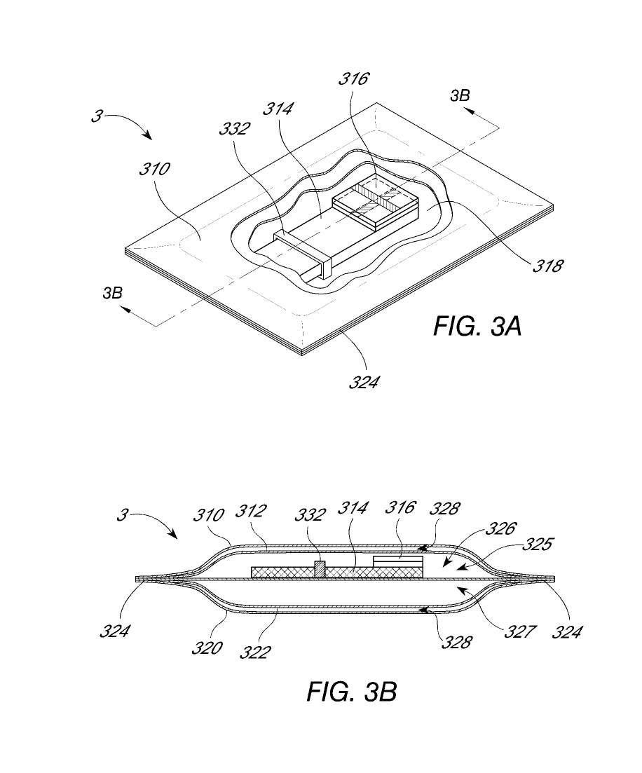

FIGS. 3A and 3B show an embodiment of a double-layer medical test package 3. The medical test package 3 is comprised of an outer top flexible sheet 310, an inner top flexible sheet 312, an outer bottom flexible sheet 320, an inner bottom flexible sheet 322, and a flexible supporting sheet 318. The medical test package 3 may include a diagnostic test device 314. The diagnostic test device 314 may be fitted with a test pad 316. The test pad 316 may contain one or more reagents that are capable of detecting one or more analytes as described above.

The characteristics and materials of the medical test package 3 are similar to those of described in relation to FIGS. 2A-2C, except, as seen in FIGS. 3A and 3B, the diagnostic test device 314 may instead (or additionally) be secured to the top of the flexible supporting sheet 318 by a retaining device 332. The retaining device 332 crosses over the diagnostic test device 314 and attaches to the top of the flexible supporting member 318 on one or both side of the diagnostic test device 314. The retaining device 332 may secure the diagnostic test device 314 in place by providing pressure to force it against the flexible supporting sheet 318, or it may secure the diagnostic test device 314 by being attached to the diagnostic test device 314 itself, in addition to being attached to the flexible supporting member 318. Securement of the medical test device 314 in this manner ensures that the test pad 316 is not damaged in transport or storage of the medical test package 3. Securement in this manner, along with inflation of the inner cavity 326, also serves to keep the medical test device 314 from moving around and keeps the test pad 316 from physically contacting the inner top flexible sheet 312 where it could inadvertently be contaminated by any contaminants or residue on the inner top flexible sheet 312.

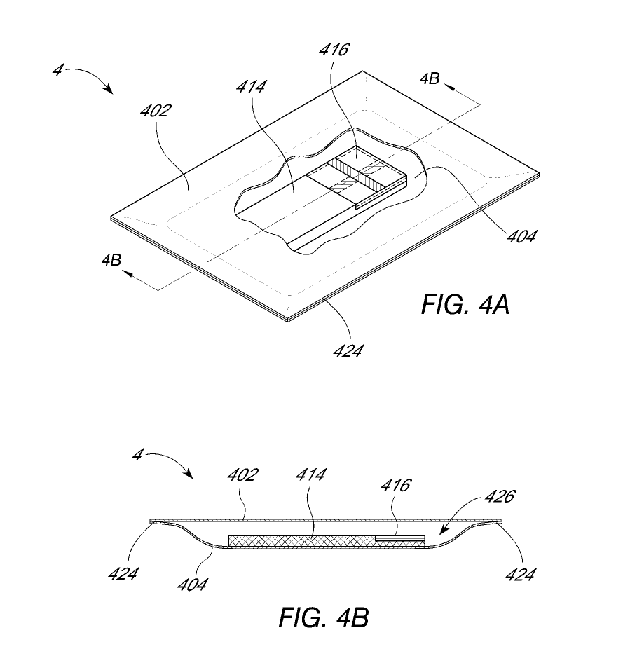

FIGS. 4A and 4B provide views of an embodiment of a medical test package 4. The medical test package 4 is comprised of a top sealing member 402 and a bottom member 404. The medical test package 4 may include a diagnostic test device 414 positioned on the inside bottom of the bottom member 404. The diagnostic test device 414 may be fitted with a test pad 416. The test pad 416 may contain one or more reagents that are capable of detecting one or more analytes.

The bottom member 404 may be rigid (for example, made of plastic) and tub-shaped and has an opening on the top. The top sealing member 402 may be made of metal foil, aluminum foil, medical aluminum foil or plastic. When the top sealing member 402 is placed over the opening in the bottom member 404, the top sealing member 402 and the bottom member 404 may be joined at a joint 424. The joint 424 acts to hermetically seal the medical test package 4 around its perimeter. By joining the top sealing member 402 and the bottom member 404 at the joint 424, a cavity 426 is formed between the top sealing member 402 and the bottom member 404. The joint 424 may be formed with ultrasound welding, with adhesives, or with resistive welding. In the process of forming the joint 424 and sealing the medical test package 4, the cavity 426 may be partially or fully inflated with one or more pressurized gases.

In one embodiment, the diagnostic test device 414 may be secured to the inside bottom of the bottom member 404 by, for example, a low-tack adhesive (not shown). Securement of the medical test device 414 in this manner ensures that the test pad 416 is not damaged in transport or storage of the medical test package 4. Securement in this manner also keeps the medical test device 414 from moving around and keeps the test pad 416 from physically contacting the top sealing member 402 where it could inadvertently be contaminated by any contaminants or residue on the top sealing member 402. For identification of the medical test package 4, a label may be affixed to top sealing member 402 or bottom member 404 or an identifying label may be printed directly on either component.

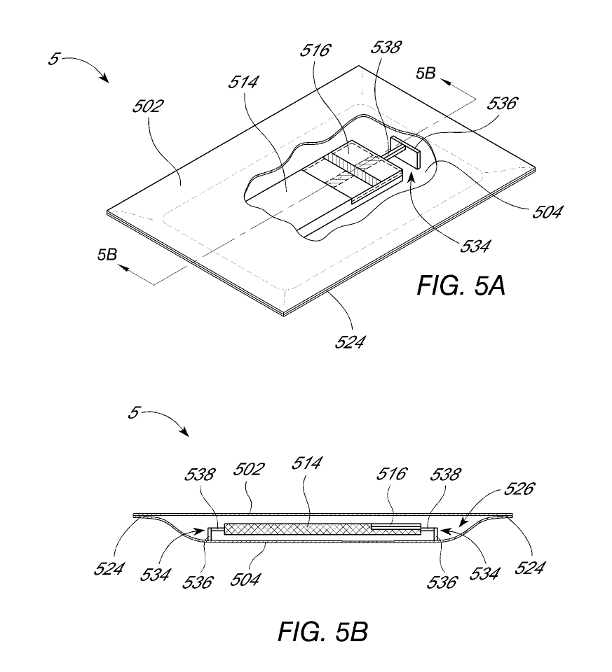

FIGS. 5A and 5B provide views of an embodiment of a medical test package 5. The medical test package 5 is comprised of a top sealing member 502 and a bottom member 504. The medical test package 5 may include a diagnostic test device 514 positioned on the inside bottom of the bottom member 504. The diagnostic test device 514 may be fitted with a test pad 516. The test pad 516 may contain one or more reagents that are capable of detecting one or more analytes.

The characteristics and materials of the medical test package 5 are similar to those of described in relation to FIGS. 4A and 4B, except, as seen in FIGS. 5A and 5B, the diagnostic test device 514 may be secured to the inside bottom of the bottom member 504 by a support structure 534. The support structure 534 may be comprised of a vertical component 536 which attaches to the inside bottom of the bottom member 504 and attaches to a horizontal component 538. In addition to be attached to the vertical component 536, the horizontal component 538 can be attached to the diagnostic test device 514. The vertical and horizontal components 536 and 538 may be spatially arranged in an orthogonal relationship to each other. The medical test package 5 may be comprised of two or more of the support structures 534 to support and secure the diagnostic test device 514.

The support structures 534 are able to raise the diagnostic test device 514 above the bottom member 504. In this manner the diagnostic test device 514 and thus, the test pad 516, are kept from making physical contact with the bottom member 504 or the top sealing member 502. By securing the diagnostic test device 514 with the support structures in this manner keeps the medical test device 514 from moving around and keeps the test pad 516 from physically contacting the top sealing member 502 or bottom member 504 where it could inadvertently be contaminated by contaminants or residue on either of those components.

### Carrier Strip

The carrier strip for the diagnostic test device maintained by the system provides structural support for the one or more test pads and the one or more boundary projections. As a structural support, many materials suitable for use in preparing the carrier strip are known in the art. Such materials include but are not limited to plastics including polyethylene terephthalate, high-density polyethylene, polypropylene, cellulose, Bakelite, polystyrene, high impact polystyrene, acrylonitrile butadiene styrene, polyester, polyurethanes, polycarbonates, polycarbonate/acrylonitrile butadiene styrene, polymethyl methacrylate, polytetrafluoroethylene, polyetherimide, phenol formaldehydes, urea-formaldehyde, melamine formaldehyde, polylactic acid, plastarch material, polyvinylchloride, nylon, and other polyamides, metals, alloys, ceramics, glass, wood, cardboard, paper, natural rubber, synthetic rubber, and other suitable polymers. Optionally, the carrier strip may be porous or non-porous. Optionally, the carrier strip may facilitate the transmission of information from the one or more test pads to a memory device. Transmitted information may include, but is not limited to, the presence, absence, and/or concentration of one or more analytes of interest. The carrier strip may facilitate the transmission of information from the one or more test pads to the one or more memory devices by any of several methods known in the art. Such methods include, but are not limited to, the transmission of electrical signals which result from changes in the coulometry, amperometry, or potentiometry of the materials comprising the carrier strip. See U.S. Pat. No. 6,743,635 (Neel et al., issued on Jun. 1, 2001) and U.S. Pat. No. 6,946,299 (Neel at al., issued on Sep. 20, 2005), which are herein incorporated by reference. Alternatively, the carrier strip may facilitate the transmission of optical signals which result from differences in the reflection, transmission, scattering, absorption, fluorescence, or electrochemiluminescense of the materials comprising the carrier strip and/or the test pads. See U.S. Pat. No. 6,040,195 (Carroll et al., issued on Mar. 21, 2000) and U.S. Pat. No. 6,284,550 (Carroll et al., issued on Sep. 4, 2001) which are herein incorporated by reference.

The carrier strip's size and shape is only limited by the desired application of the embodiment. For example, if the desired application is testing a human patient, the embodiment, and consequently the carrier strip, may be smaller or larger depending upon the size of the human patient. Likewise, if the desired application involves testing an animal patient, the embodiment, and consequently the carrier strip, may be smaller or larger depending upon the size of the animal patient. In some embodiments, the carrier strip is about 1, about 1.25, about 1.5, about 1.75, about 2, about 2.25, about 2.5, about 2.75, about 3, about 3.25, about 3.5, about 3.75, about 4, about 1-2, about 1-3, about 1-4, about 2-3, about 2-4, or about 3-4 inches in length. The carrier strip's shape may optionally be varied depending upon the desired application of the embodiment. Some applications may require substantially narrow, fat, rectangular, circular, oval, square, triangular, or other shapes, including combinations of the indicated shapes. It is envisioned that the shape of embodiments can be tailored to the shape of the environment in which the embodiments will be applied. Moreover, the carrier strip may contain boundary projections that substantially surround one, two, three, and/or four sides of one or more test pads to collect and/or direct sample application to the one or more test pads. Furthermore, it is envisioned that a handle may be optionally attached to a carrier strip or in contact with a carrier strip, either directly or indirectly.

### Test Reagents and Signaling Reagents

Test reagents and signaling reagents suitable for inclusion in embodiments are well known in the art. Such reagents include, but are not limited to, polyclonal antisera and monoclonal antibodies that have specific binding properties and high affinity for virtually any antigenic substance. Literature affords many means of preparing such reagents. See, e.g., Laboratory Techniques in Biochemistry and Molecular Biology, Tijssen, Vol. 15, Practice and Theory of Enzyme Immunoassays, chapter 13, The immobilization of Immunoreactants on Solid Phases, pp. 297-328, and the references cited therein which are herein incorporated by reference. Additional assay protocols, reagents, and analytes useful in the practice of the invention are known per se. See, e.g., U.S. Pat. No. 4,313,734 (Leuvering, issued on Feb. 2, 1982), columns 4-18, and U.S. Pat. No. 4,366,241 (Tom et al., issued on Dec. 28, 1982), columns 5-40 which are herein incorporated by reference.

Metal sols, including but not limited to gold sol, and other types of colored particles, including but not limited to, organic dye sols and colored latex particles, that are useful as marker substances in immunoassay procedures are also known per se and suitable for use as test reagents and/or signaling reagents. See, for example, U.S. Pat. No. 4,313,734 (Leuvering, issued on Feb. 2, 1982), the disclosure of which is incorporated herein by reference. For details and engineering principles involved in the synthesis of colored particle conjugates see Horisberger, Evaluation of Colloidal Gold as a Cytochromic Marker for Transmission and Scanning Electron Microscopy, Biol. Cellulaire, 36, 253-258 (1979); Leuvering et al, Sol Particle Immunoassay, J. Immunoassay 1 (1), 77-91 (1980), and Frens, Controlled Nucleation for the Regulation of the Particle Size in Monodisperse Gold Suspensions, Nature, Physical Science, 241, pp. 20-22 (1973) which are herein incorporated by reference.

Test reagents for inclusion in the embodiments may signal directly, such as with an electrical or optical signal (visible either to the naked eye, or with an optical filter or upon applied stimulation to promote fluorescence or phosphorescence). Test reagents may also signal indirectly such as with enzymes, e.g. alkaline phosphatase and/or horseradish peroxidase, in combination with signaling reagents in the form of enzymatic substrates that will generate a signal upon interaction with the enzyme. In some embodiments, the signaling reagent and/or test reagent is incorporated into the test pad. In other embodiments, the signaling reagent and/or test reagent is added to the test sample before application to the test pad. In additional embodiments, the signaling reagent and/or test reagent is added to the test pad after introduction of the test sample.

Alcohol sensitive test reagents and methods are well known in the art. See, e.g. U.S. Pat. No. 5,563,073 (Titmas, issued on Oct. 8, 1996) and Jai Moo Shin et al., Simple Diagnostic Tests to Detect Toxic Alcohol Intoxications, NIH (October 2008), which are hereby incorporated by reference in their entirety. In some embodiments, the test reagent and/or signaling reagent from Alco Screen™ pads, manufactured by Chematics, Inc. located in North Webster, Ind., is incorporated. Optionally, the test reagent and/or signaling reagent from Alco Screen™ pads is incorporated in the one or more test pads, but it may also be applied to the test pad after sample application or it may be applied to the sample before application to the test pad. In some embodiments the test reagent and/or signaling reagent from the alcohol dehydrogenase method (ADH method) is incorporated in the one or more test pads, but it may also be applied to the test pad after sample application or it may be applied to the sample before application to the test pad. In some embodiments the test reagent and/or signaling reagent from the alcohol oxidase method method (ALOx method) is incorporated in the one or more test pads, but it may also be applied to the test pad after sample application or it may be applied to the sample before application to the test pad. In some embodiments the test reagent and/or signaling reagent from the sodium periodate method is incorporated in the one or more test pads, but it may also be applied to the test pad after sample application or it may be applied to the sample before application to the test pad. In some embodiments the test reagent and/or signaling reagent from the potassium permanganate method (PA method) is incorporated in the one or more test pads, but it may also be applied to the test pad after sample application or it may be applied to the sample before application to the test pad.

Test reagents and/or signaling reagents may also detect the storage and handling of embodiments. In some embodiments, test reagents and/or signaling reagents may be sensitive to temperature and if the temperature of the embodiment's environment has exceeded or fallen below a predetermined temperature, optionally for a predetermined period of time, the test reagents and/or signaling reagents may be inactivated. Optionally, the inactivation of the test reagents and/or signaling reagents may result in the transmission of a signal to the one or more memory devices and/or to the user of the embodiment.

In some embodiments, test reagents and/or signaling reagents may be sensitive to moisture, and if the humidity of the embodiment's environment has exceeded or fallen below a predetermined level, optionally for a predetermined period of time, the test reagents and/or signaling reagents may be inactivated. Optionally, the inactivation of the test reagents and/or signaling reagents may result in the transmission of a signal to the one or more memory devices and/or to the user of the embodiment.

Test reagents and/or signaling reagents may also detect whether a sufficient amount of sample has been applied to an embodiment for analysis. For example, when the sample is saliva, a test reagent and/or signaling reagent specific for a salivary enzyme, such as amylase, may detect the salivary enzyme's presence if a sufficient volume of sample has been applied. The detection of a sufficient sample may optionally be signaled to the user in the form of a color or symbol. Using such embodiments, the user would then know if a sufficient quantity of sample was applied to the one or more test pads to afford an accurate analysis.

Embodiments that detect storage and/or sufficient application of sample volume are particularly capable of reducing the occurrence of false negatives. For example, poor storage conditions may inactivate a test reagent in a test pad. Upon application of sample to such a test pad, no signal may result and a user could believe that an analyte is not present—a false negative. Alternatively, test pads having a pre-printed negative signal may suffer a similar occurrence of a false negative if the test reagent is inactivated because an analytes presence in a sample would not convert the pre-printed negative signal into a positive signal. Likewise, an insufficient volume of sample may generate no signal or a negative signal and cause a user to believe that an analyte is not present.

Any enzyme, antibody, dye buffer, chemical, sol, or combinations thereof may be incorporated so long as the enzyme, antibody, dye buffer, chemical, metal sol, or combinations thereof are capable of detecting the presence of one or more analytes in a sample. See, e.g., U.S. Pat. No. 6,383,736 (Titmas, issued on May 7, 2002), U.S. Pat. No. 7,858,756 (Owens et al., issued on Dec. 28, 2010), and U.S. Pat. No. 7,790,400 (Jehanli et al., issued on Sep. 7, 2010) which are hereby incorporated by reference in their entirety.

### Test Pads

The one or more test pads may be prepared from any bibulous, porous, fibrous, or sorbent material capable of rapidly absorbing a sample. Porous plastics material, such as polypropylene, polyethylene, polyvinylidene flouride, ethylene vinylacetate, acrylonitrile and polytetrafluoroethylene can be used. Optionally, the one or more test pads can be pre-treated with a surface-active agent to reduce any inherent hydrophobicity in the one or more test pads and enhance their ability to absorb a sample. Moreover any one of the one or more test pads may be treated with an oxygen-impermeable water soluble substance. Suitable examples of an oxygen-impermeable water soluble substance include, but are not limited to, polyvinyl alcohol, partly saponified polyvinyl acetate which can also contain vinylether and vinylacetal units, polyvinyl pyrrolidone and copolymers thereof with vinyl acetate and vinyl ethers, hydroxy alkyl cellulose, gelatin, polyacrylic acid, gum arabic, polyacryl amide, dextrin, cyclodextrin, copolymers of alkylvinyl ethers and maleic acid anhydride, ring opened polymers of maleic acid anhydride, water-soluble high molecular polymers of ethylene oxide having molecular weights of above 5,000, and/or polyvinyl alcohol in combination with poly(1-vinylimidazole) or a copolymer of 1-vinyl-imidazole. The one or more test pads can also be made from paper or other cellulosic materials, including but not limited to nitrocellulose. Materials that are now used in the nibs of fiber-tipped pens are also suitable for incorporation in the one or more test pads.

Optionally, the one or more test pads may be prepared from non-porous materials. In such circumstances, the test reagents and/or signaling reagents may be coated on the outer surface of the one or more test pads such that contact with a sample containing an analyte will result in the generation of a signal.

Using known methods, test pads may be shaped or extruded in a variety of lengths and cross-sections. Embodiments may possess one or more test pads of various sizes and shapes, and the size and shape of the one or more test pads are only limited by their number, size, and desired application of the embodiment in which they are incorporated within. In some embodiments, the one or more test pads are substantially similar in size and/or shape. In other embodiments, the one or more test pads may differ substantially in size and/or shape. It is readily envisioned that embodiments may possess about one or more test pads, about two or more test pads, about three or more test pads, about four or more test pads, about five or more test pads, about six or more test pads, about seven or more test pads, about eight or more test pads, about nine or more test pads, about ten or more test pads, about 1-4 test pads, about 1-10 test pads about 1-100 test pads, about 2-100 test pads, about 3-100 test pads, about 4-100 test pads, about 5-100 test pads, about 5-75 test pads, about 10-50 test pads, about 15-25 test pads, and individual numbers of test pads therein. The one or more test pads may be made of the same material, or optionally they may be made of different materials or even combinations of different materials. Moreover, the one or more test pads may be recessed into the carrier strip.

In some embodiments, test pads may be prepared from a single layer of material. In other embodiments, test pads may be prepared from multiple layers of material. It is readily envisioned that embodiments may possess about one or more layers, about two or more layers, about three or more layers, about four or more layers, about five or more layers, about six or more layers, about seven or more layers, about eight or more layers, about nine or more layers, about ten or more layers, about 1-4 layers, about 1-5 layers, about 1-6 layers, about 1-7 layers, about 1-8 layers, about 1-9 layers, about 1-10 layers, about 1-100 layers, about 2-100 layers, about 3-100 layers, about 4-100 layers, about 5-100 layers, about 5-75 layers, about 10-50 layers, about 15-25 layers, and individual numbers of layers therein.

The test pad layers may be of the same or different materials. Test reagents and/or signaling reagents may also be impregnated in a single layer of material or in multiple layers of material. The impregnation may take any suitable form, including, but not limited to, a substantially uniform impregnation or impregnation with dots or stripes. Test reagents and/or signaling reagents can be impregnated in various concentrations in one or more of the multiple layers to tailor the sensitivity of the test pads to certain analytes. Such sensitivity could afford information about the concentration of an analyte in the sample. Furthermore, the impregnation may optionally be conducted in a manner that will generate a signal observable by the user upon application of a sufficient quantity of sample, detection of an analyte, or proper/improper storage of the embodiment.

When one or more test pads are comprised of multiple layers of material, one or more layers of material may be impregnated (e.g. pre-printed) with an inert chemical such that a line or “minus sign” is displayed to the user. In some embodiments, the line or “minus sign” could be in the form of a material covering the one or more test pads to give a visual impression of a line or “minus sign” on the one or more test pads. One or more additional layers of the material comprising the one or more test pads could then be impregnated with a test reagent and/or a signaling reagent that upon detecting a sufficient quantity of sample, appropriate storage temperature, and/or the presence of an analyte, the impregnated test reagent and/or signaling reagent will create a perpendicular line such that a “plus sign” will be signaled to the user. In other embodiments, the line or “minus sign” displayed in the one or more test pads could be obscured by color or opaqueness when a test reagent and/or a signaling reagent detects a sufficient quantity of sample, appropriate or inappropriate storage temperature, and/or the presence of an analyte.

The test pad layers may comprise optically transparent membranes. Detection on an analyte may then generate a signal that is opaque, partially transparent, or completely transparent. Moreover, test pad layers may be only partially optically transparent prior to application of a sample. Alternatively, the application of a sample to one or more test pad layers may result in the layers becoming optically transparent, thereby allowing a user to see generated and/or pre-printed signals on test pad layers below the optically transparent layers. Moreover, the individual layers in a test pad may be positioned such that the detection of an analyte in a lower layer of material is obscured by the detection of an analyte in a layer of material positioned above the lower layer.

It is also envisioned that embodiments may have arrangements of test pads and/or arrangements of layers within multiple layered test pads such that the detection of an analyte in the test pads or the layers of a test pad generate a signal, such as a “plus sign” or “minus sign” to the user. Such embodiments may comprise at least two layers of material, each capable of generating a line upon detecting an analyte or a certain concentration of an analyte. Optionally, the lines may intersect to generate a “plus” sign or other signal upon the detection of an analyte in the at least two layers of material. Alternatively, embodiments may comprise at least four layers of material, each capable of generating a line upon detecting an analyte or a certain concentration of an analyte in the at least four layers of material. Optionally, the lines may intersect at one or more points such that a “plus” sign or other symbol is formed. While the aforementioned embodiments have been discussed with reference to “minus” and “plus” signs, it is envisioned that any symbol, including color changes, could be used to convey similar information to a user. Such symbols include, but are not limited to, circles, ovals, squares, triangles, trapezoids, rhombi, plus signs, minus signs, “X” shaped signs, checkmarks, and/or dotted, dashed, or differentially colored version of said symbols. The meaning of any desired symbol or color change could be included in the packaging of an embodiment or imprinted on an embodiment.

The test reagents applied to each layer of material may optionally be the same or different. When different test reagents are applied to different layers of material comprising the one or more test pads, the test pad may be tailored to generate a signal indicating the diagnosis of one or more illnesses, diseases, or injuries. One method for achieving such a diagnosis would be to have the individual layers comprising the test pad generate a signal in response to one or more symptoms of one or more illnesses, diseases, or injuries. For example, if the diagnosis of one or more illnesses, diseases, or injuries required the determination of multiple analytes, then the detection of each analyte could produce a portion of a symbol that is visible to the user. Upon formation of a complete symbol, the embodiment would confirm the presence of a certain illness, disease, or injury. Optionally, information relating to each specific analyte could be transferred to the one or more memory devices.

One can readily appreciate the application of such embodiments of multiple layer test pads when knowledge of a certain concentration is needed. As a non-limiting application, the detection of a person's blood alcohol level may be achieved using such an embodiment. For a test pad comprising at least four test pad layers, if a first test pad layer was sensitive to a blood alcohol level of at least 0.02%, a second test pad layer was sensitive to a blood alcohol level of at least 0.04%, a third test pad layer was sensitive to a blood alcohol level of at least 0.06%, and a fourth test pad layer was sensitive to a blood alcohol level of at least 0.08%, then the application of a sample having a blood alcohol level at least at the sensitive percentages would generate a signal. Assuming that operating a motor vehicle with a blood alcohol level equal to or greater than 0.08% is illegal, then the application of a sample that generates a “plus” sign would indicate that the sample provider should not legally operate a motor vehicle. One will readily appreciate that this described example is capable of extension to any number of test pads having any number of layers, such that the detection of an analyte in each layer generates a signal indicative of concentration.

As another non-limiting example, test reagents and/or signaling reagents that are sensitive to markers specific for hepatitis and/or liver damage may be applied to test pads and/or layers within test pads. Consequently, the detection of markers specific for hepatitis and/or liver damage in each test pad and/or layers within test pads would generate a signal. An individual test pad may optionally be sensitive to a single marker for hepatitis and/or liver damage. Alternatively, a single test pad may be sensitive to multiple markers for hepatitis and/or liver damage. In such an embodiment, the detection of one or more markers for hepatitis and/or liver damage may produce a certain signal, e.g. color, indicative of the number of markers detected and/or indicative of the exact marker detected. Alternatively, an embodiment may produce a signal in the form of a shape that indicates the presence of one or more markers indicative of hepatitis and/or liver damage. For example, an embodiment may have a test pad with four or more test pad layers, while each layer may be sensitive to one or more markers specific to an analyte such as viral hepatitis. The respective detection of a marker in each of the test pad would generate a signal such that the detection of a marker in each of the test pad layers would confirm the diagnosis of a viral hepatitis. Although such an embodiment has been described with specific references to a viral hepatitis, it is envisioned that such an embodiment may readily be tailored to detect any number of analytes and/or markers that are specific to any analyte described below.

Embodiments may optionally possess one or more test pads and test reagents that detect analytes important to a certain age population (e.g. infants, children, young adults, adults, or elderly individuals). It is also envisioned that embodiments could possess one or more test pads and test reagents that detect analytes important to certain categories of individuals (e.g., law enforcement agents, government employers, military members, chronic drug users, physicians, veterinarians, dentists, parents, private sector employers, aid workers, inmates, hospital patients, nursing home patients, outdoorsmen, immuno-compromised individuals, or students). Embodiments may also be directed to analytes important to geographic regions (e.g. third-world countries, developed countries, or specific climate regions). Such embodiments of the invention simplify the number of different embodiments that a user must purchase or travel with because users can select embodiments that will detect the analytes the users are most interested in, or are most pertinent to a user's current or impending circumstances.

In one embodiment, a single test pad contains or has applied to it a single test reagent and/or signaling reagent suitable for detecting a single analyte. In another embodiment, two or more test pads contain or have applied to one or more of them a single test reagent and/or signaling reagent suitable for detecting a single analyte. Optionally, the single test reagent and/or signaling reagent on or applied to the two or more test pads may be the same or different. Furthermore, when different test reagents and/or signaling reagents are used, the test reagents may be sensitive to the same marker on an analyte or the test reagents may be sensitive to different markers on an analyte. The analyte may optionally be the same or different. When different analytes and different test reagents and/or signaling reagents are used, the analytes and test reagent and/or signaling reagents may be tailored to detect different symptoms of the same illness, disease, or injury. In some embodiments, a diagnosis can be made based upon the detection of all the symptoms specific to an illness, disease, or injury. In other embodiments, a diagnosis can be made based upon the absence of one or more analytes specific to an illness, disease, or injury. Using these described test pads, it is readily apparent that the reduction of false negatives and false positives can be achieved by including redundancy in the embodiments.

In one embodiment, a single test pad may contain or have applied to it two or more reagents suitable for detecting and/or signaling a single analyte. These two or more test reagents and/or signaling reagents may be sensitive to the same marker of an analyte. Optionally, these two or more reagents may be sensitive to different markers on the same analyte. In some embodiments, the two or more test reagents and/or signaling reagents may be applied to the same region of the test pad. In other embodiments, the two or more test reagents and/or signaling reagents may be applied to different regions of the same test pad. The number of test reagents and/or signaling reagents suitable for incorporation or application to a single test pad is limited only by the application of the diagnostic test strip. It is readily envisioned that embodiments may possess about one or more, about two or more, about three or more, about four or more, about five or more, about six or more, about seven or more, about eight or more, about nine or more, about ten or more, about 1-4, about 1-10, about 1-100, about 2-100, about 3-100, about 4-100, about 5-100, about 5-75, about 10-50, about 15-25, and individual numbers therein, of test reagents and/or signaling reagents incorporated or applied to one or more test pads. Using these described test pads, it is readily apparent that the reduction of false negatives and false positives can be achieved by including redundancy in the embodiments.

The one or more test pads suitable for use in an embodiment will readily detect analytes present in liquid samples, such as saliva. It is also envisioned that a test pad may be capable of detecting an analyte present in solid and/or semi-solid samples. When solid and/or semi-solid samples are analyzed, it is understood that a liquid may optionally be applied to the test pad to facilitate analysis.

When liquids and/or liquid samples are applied to test pads, lateral flow through material may result from surface tension, cohesion, adhesion, wicking, and/or capillary action. In general, embodiments that utilize lateral flow will require substantial amounts of a liquid sample for sufficient contacting of the sample with a devices test area. In some embodiments, lateral flow is confined to the test pad region. In other embodiments, lateral flow is confined to individual test pads. In further embodiments, lateral flow is confined to individual layers of a multi-layer test pad. Moreover, some embodiments overcome the use of lateral flow by having a test pad designed to absorb the fluid sample without requiring surface tension, cohesion, adhesion, wicking, and/or capillary action to contact the fluid sample with the test area. Such embodiments are particularly suited for use when the volume of a fluid sample is small and/or limited. This includes, but is not limited to, instances when the fluid sample is oral fluid such as saliva.

### Analytes

An assay based on the principles described herein can be used to determine a wide variety of analytes by choice of appropriate test reagents and/or signaling reagents. The embodiments described herein can be used to test for the existence of analytes including, but not limited to, drugs, especially drugs of abuse; heavy metals; pesticides; pollutants; proteins; polynucleotides such as DNA, RNA, rRNA, tRNA, mRNA, and siRNA; hormones; vitamins; microorganisms such as bacteria, fungi, algae, protozoa, multi-cellular parasites, and viruses; tumor markers; liver function markers; kidney function markers; blood coagulation factors; and toxins. The embodiments may also optionally detect metabolites of each of the aforementioned examples of analytes. Furthermore, some embodiments may also detect their storage conditions, specifically the temperature and humidity of their environment, and/or the application of an appropriate quantity of sample for analysis.

Analytes may be reference analytes or target analytes. Any given analyte may be either a reference analyte or a target analyte, depending upon the desired application. Indeed, any analyte described below that is known to consistently be present in a given sample may serve as a reference analyte. As a non-limiting example, alpha-amylase is an enzyme present in saliva and could serve as a reference analyte when the analyzed sample is saliva. However, methadone could serve as a reference analyte when an embodiment is desired for use with samples obtained from patients generally known and/or suspected of having methadone in their system. Thus, one will readily appreciate that it is the application of the embodiment that determines the analytes classified as references or targets.

More specific examples of drug analytes, including both drugs of abuse and therapeutic drugs, include opiates, which includes but is not limited to methadone, morphine, heroin, dextromethorphen, meperidine, codeine, hydromorphone, pholcodine, and metabolites thereof.

More specific examples of drug analytes, including both drugs of abuse and therapeutic drugs, include benzheterocyclics, the heterocyclic rings being azepines, diazepines and phenothiazines. Examples of azepines include fenoldopam. Examples of benzodiazepines include alprazolam, bretazenil, bromazepam, chlorodiazepoxide, cinolazepam, clonazepam, cloxazolam, clorazepate, diazepam, estazolam, fludiazepam, flunirazepam, flurazepam, flutoprazepam, halazepam, ketazolam, loprazolam, lorazepam, lormetazepam, medazepam, midazolam, nimetazepam, nitrazepam, nordiazepam, N-Desmethyld, oxazepam, phenazepam, pinazepam, prazepam, premazepam, quazepam, temazepam, tetrazepam, triazolam, and other benzodiazepine receptor ligands such as clobazam, DMCM, flumazenil, eszopiclone, zaleplon, zolpidem, and zopiclone. Examples of phenothiazines include chlorpromazine, promethazine, triflupromazine, methotrimeprazine, mesoridazine, thioridazine, fluphenazine, perphenazine, prochlorperazine, and trifluoperazine. Examples of other benzheterocyclics include, but are not limited to, carbamazepine and imipramine.

Additional drug analytes, including both drugs of abuse and therapeutic drugs, include alkaloids, such as agents that interact with opioid receptors including morphine, dihydromorphine, desomorphine, hydromorphone, nicomorphine, oxymorphone, hydromorphinol, nalbuphine, naloxone, naltrexone, buprenorphine, etorphine, metopon, diacetyldihydromorphine, thebacon, methodone, codeine, hydrocodone, dihydrocodeine, oxycodone, papaveretum, oripavine, thebaine, tapentadol, and heroin; agents that exert effects on serotonin receptors, such as cocaine (and other reuptake inhibitors, including norepinephrine, dopamine, and serotonin reuptake inhibitors); cocaine metabolites such as benzoylecgonine; ergot alkaloids; steroid alkaloids; iminazoyl alkaloids; quinazoline alkaloids; isoquinoline alkaloids; quinoline alkaloids; and diterpene alkaloids.

Another group of drug analytes, including both drugs of abuse and therapeutic drugs, includes steroids, including the estrogens, gestogens, androgens, andrenocortical steroids, bile acids, cardiotonic glycosides and aglycones, which includes digoxin and digoxigenin, saponins and sapogenins, their derivatives and metabolites.

Additional drug analytes, including both drugs of abuse and therapeutic drugs, is the barbiturates, such as barbital, allobarbital, amobarbital, aprobarbital, alphenal, brallobarbital, hexobarbital, Phenobarbital, phencyclidine (PCP), pentobarbital, Nembutal, secobarbital, diphenylhydantonin, primidone, and ethosuximide. Additionally, drugs similar in effect to barbiturates are potential analytes, such as methaqualone, cloroqualone, diproqualone, etaqualone, mebroqualone, mecloqualone, methylmethaqualone, and nitromethaqualone.

Another group of drug analytes, including both drugs of abuse and therapeutic drugs, is aminoalkylbenzenes, including the phenethylamines such as amphetamine, methamphetamine, ephedrine, amphepramone, prolintane, lisdexamfetamine, mescaline, and catecholamines, which includes ephedrine, L-dopa, epinephrine, narceine, and papaverine.

Additional drug analytes, including both drugs of abuse and therapeutic drugs, includes those derived from marijuana, which includes cannabinol, tetrahydrocannabinol, 11-nor-9-carboxy-delta-9-tetrahydrocannabinol (THC), nabilone, dronabinol, marinol, and cannabinoids such as cannabidiol, cannabinol, and tetrahydrocannabivarin.

Another group of drug analytes, including both drugs of abuse and therapeutic drugs, are those that interact with the N-methyl d-aspartate (“NMDA”) receptor, including agonists, modulators, and antagonists such as 1-(1-phylcyclohexyl)piperidine (phencyclidine or “PCP”), R-2-amino-5-phosphonopentanoate, 2-amino-7-phosphonoheptanoic acid, (3-[(R)-2-carboxypiperazin-4-yl]-prop-2-enyl-1-phosphonic acid), PEAQX, selfotel, amantadine, dextrallorphan, dextromethorphan, dextrorphan, dizocilpine, ethanol, eticyclidine, gacyclidine, ibogaine, ketamine, memantine, methoxetamine, rolicyclidine, tenocyclidine, tiletamine, neramexane, eliprodil, etoxadrol, dexoxadrol, NEFA, remacemide, delucemine, 8A-PDHQ, aptiganel, HU-211, remacemide, atomoxetine, rhynchophylline, 1-aminocyclopropanecarboxylic acid, 7-chlorokynurenate, 5,7-dichlorokynurenic acid, kynurenic acid, and lacosamide.

Another group of therapeutic drugs is antibiotics, which include, for example, beta-lactam antiobiotics such as penicillins and cephalosporins, penems and carbapenems, antimicrobials such as aminoglycosides, ansamycins, carbacephems, glycopeptides, lincosamides, lipopetides, macrolides, monobactams, nitrofurans, quionolones, polypeptide-based antibiotics, chloromycetin, actinomycetin, spectinomycin, sulphonamides, trimethoprim, tetracyclines, and beta-lactamase inhibitors such as calvulanic acid, tazobactam, and sulbactam.

Other individual miscellaneous drug analytes, including both drugs of abuse and therapeutic drugs, include nicotine, caffeine, cotinine, gamma-hydroxybutyric acid, dextromoramide, ketobemidone, piritramide, dipipanone, phenadoxone, benzylmorphine, codeine, nicocodeine, dihydrocodeinone enol acetate, tilidine, meptazinol, propiram, acetyldihydrocodeine, pholcodine, 3,4-methylenedioxymethamphetamine, psilocybin, 5-methoxy-N,N-diisopropyltryptamine, peyote, 2,5-dimethoxy-4-methylamphetamine, 2C-T-7 (a psychotropic entheogen), 2C-B, cathinone, alpha-methyltryptamine, bufotenin, benzylpiperazine, methylphenidate, dexmethylphenidate, laudanum, fentanyl, mixed amphetamine salts (i.e. Adderall), lisdexamfetamine, dextroamphetamine, dextromethamphetamine, phentermine, phylpropanolamine, ephedrine, pethidine, anabolic steroids, talbutal, butalbital, buprenorphine, xyrem, paregoric, modafinil, difenoxin, diphenoxylate, promethazine, pregabaline, pyrovalerone, atropine, and other Schedule I-V classified drugs, glucose, cholesterol, bile acids, fructosamine, carbohydrates, metals which includes, but is not limited to lead and arsenic, alcohols (i.e. methanol, ethanol, propanol, butanol, ethylene glycol, diethylene glycol, C₅₋₁₀ containing alcohols, and metabolites thereof), meprobamate, serotonin, meperidine, amitriptyline, nortriptyline, lidocaine, procaineamide, acetylprocainearnide, propranolol, griseofulvin, valproic acid, butyrophenones, antihistamines, and anticholinergic drugs, such as atropine.

Pesticide analytes of interest include categories such as algicides, avicides, bactericides, fungicides, herbicides, insecticides, miticides, molluscicides, nematicides, rodenticides, virucides, and specifically polyhalogenated biphenyls, phosphate esters, thiophosphates, carbamates, and polyhalogenated sulfenamides.

Additional chemical analytes of interest include fertilizers such as ammonium derivatives, nitrates, and phosphates; heavy metals such as lead, mercury, uranium, plutonium, arsenic, cadmium, chromium, and nickel

More specific examples of protein analytes include antibodies, protamines, histones, albumins, globulins, scleroproteins, phosphoproteins, mucoproteins, chromoproteins, lipoproteins, nucleoproteins, glycoproteins, proteoglycans, and unclassified proteins, such as somatotropin, prolactin, insulin, and pepsin. A number of proteins found in the human plasma are important clinically and include prealbumin, albumin, α₁-lipoprotein, α₁-acid glycoprotein, α₁-antitrypsin, α₁-glycoprotein, transcortin, 4.6S-postalbumin, tryptophan-poor, α₁-glycoprotein, α₁X-glycoprotein, thyroxin-binding globulin, inter-α-trypsin-inhibitor, Gc-globulin (Gc I-I, Gc 2-1, Gc 2-2), haptoglobin, ceruloplasmin, cholinesterase, α₂-lipoprotein(s), myoglobin, C-reactive Protein, α₂-macroglobulin, α₂-HS-glycoprotein, Zn-α₂-glycoprotein, α₂-neuramino-glycoprotein, erythropoietin, β-lipoprotein, transferrin, hemopexin, fibrinogen, plasminogen, β₂-glycoprotein I, β₂-glycoprotein II, immunoglobulins A, D, E, G, M, prothrombin, thrombin, and protein markers in cancers including, but not limited to, breast cancer, prostate cancer, melanoma, carcinoma, pancreatic cancer, liver cancer, and brain cancer.

Additional protein analytes of interest include alanine aminotransferase and aspartate aminotransferase. Alanine aminotransferase is markedly elevated when hepatitis is present in the liver. Such elevation for alanine aminotransferase may include at least about 1.25, 1.5, 1.75, 2, 2.25, 2.5, 2.75, and 3.0 times the normal levels associated with a person lacking liver damage. Aspartate aminotransferase is elevated when cellular damage occurs, such as liver damage, skeletal muscle damage, and acute myocardial infarction. Additionally, levels are elevated because of congestive heart failure, pericarditis, cirrhosis, metastatic liver disease, skeletal muscle diseases, and generalized infections such as mononucleosis. Such elevation for aspartate aminotransferase may include at least about 1.25, 1.5, 1.75, 2, 2.25, 2.5, 2.75, and 3.0 times the normal levels associated with a person lacking liver damage. Consequently, the detection of alanine aminotransferase and/or aspartate aminotransferase is of therapeutic importance.

Specific examples of peptide and protein hormone analytes include parathyroid hormone (parathromone), thyrocalcitonin, insulin, glucagon, relaxin, erythropoietin, melanotropin (melanocyte-stimulating hormone and intermedin), somatotropin (growth hormone), corticotropin (adrenocorticotropic hormone), thyrotropin, prolactin, follicle-stimulating hormone, luteinizing hormone), chorionic gonadotropin (hCG), oxytocin, and vasopressin.

Specific examples of polynucleotide analytes include DNA and RNA as well as their nucleoside and nucleotide precursors, which include ATP, NAD, FMN, adenosine, guanosine, thymidine, cytidine, and uracil with their appropriate sugar and phosphate substituents.

Specific examples of vitamin analytes include Vitamin A (i.e. retinol), B (e.g. B₁ or thiamine, B₂ or riboflavin, B₃ or niacin, B₅ or pantothenate, B₆ or pyridoxine, B₇ or biotin, B₉ or folic acid, and B₁₂), C (i.e. ascorbic acid), D (e.g. calciferol, D₂, and D₃), E (i.e. tocopherol), K, and vitamin derivatives or metabolites such as nicotinamide.

Specific examples of microorganism analytes, including infectious disease agents, include corynebacteria, pneumococci, streptococci, staphylococci, neisseriae, hemophilus influenzae, pasteurellae, brucellae, aerobic spore-forming bacilli, anaerobic spore-forming bacilli, mycobacteria, actinomycetes (fungus-like bacteria), the spirochetes, mycoplasmas, and other pathogens, such as listeria monocytogenes, erysipelothrix rhusiopathiae, streptobacillus moniliformis, donvania granulomatis, bartonella bacilliformis, rickettsiae (bacteria-like parasites), fungi, agents causing venereal diseases such as chlamydia, chancroid, granuloma inguinale, gonorrhea, syphilis, jock itch, yeast infection, herpes simplex, HPV, crab louse, scabies, trichomoniasis, and infectious diarrheal microorganisms such as camplylobacter, salmonellae, shigellae, Escherichia coli, Clostridium difficile, Giardia lamblia, Entamoeba histolytica, and organisms causing leptospirosis, nosocomial infections, staphylococcal enterotoxicosis, typhoid fever, cholera, vibrio gastroenteritis, yersinia gastroenteritis, clostridium perfringens gastroenteritis, bacillus cereus gastroenteritis, aflatoxin poisoning, amoebic dysentery, cryptosporidiosis, cyclospora diarrheal infection. Other microorganism analytes include viruses, such as herpes viruses, pox viruses, picornaviruses, myxoviruses (influenza A, B, and C, and mumps, measles, rubella, etc.), arboviruses, reoviruses, rotoviruses, noroviruses, adenoviruses, astroviruses, hepatitis, human immunodeficiency virus, and tumor viruses.

The categories of protein analytes and microorganism analytes may optionally overlap. For example, a microorganism analyte may be detected via the analysis of a protein analyte specific for the microorganism analyte. A protein analyte specific for a microorganism analyte may include an antibody specific for a microorganism analyte, or marker thereof. As a non-limiting example, for a microorganism analyte such as viral hepatitis, antibodies specific to any of viral hepatitis A, B, C, D, E, F and/or G may comprise the protein analyte. Such antibodies include, but are not limited to, immunoglobins such as IgA, IgD, IgE, and specifically IgM and/or IgG, and antibodies to surface antigens, envelope antigens, core antigens, and/or delta antigens (e.g. small and/or large). Specific examples of antigens for viral hepatitis B include hepatitis B surface antigen (HBsAg), hepatitis B envelope antigen (HBeAg), hepatitis B core antigen (HBcAg). Alternatively, a protein analyte specific for a microorganism analyte may include a protein analyte characteristically produced by the microorganism analyte. As a non-limiting example, for a microorganism analyte such as viral hepatitis, proteins specific to any of viral hepatitis A, B, C, D, E, and/or F may comprise the protein analyte. Such protein analytes include, but are not limited to, structural and/or nonstructural proteins. Specific examples of protein analytes for viral hepatitis C include, but are not limited to structural proteins such as E1 and/or E2, and/or nonstructural proteins such as NS2, NS3, NS4, NS4A, NS4B, NS5, NS5A, NS5B, and peptide portions thereof.

The above described analytes possess at least one marker recognized by at least one test reagent and/or signaling reagent. Optionally, the above described analytes may possess multiple markers recognized by the same and/or different test reagents and/or signaling reagents. It is readily envisioned that a marker may be the entire analyte and/or a portion thereof.

A preferred embodiment are testing for analytes detectable through saliva. It is beneficial to test for analytes to aid in the detection of drugs of abuse and thereapeutic drugs, as well as cancer markers, disease markers, hormonal markers, glucose and metabolites.

More specific examples of salivary drug analytes for detecting both drugs of abuse and therapeutic drugs are ethanol, methanol, ethylene glycol, and diethylene glycol.

More specific examples of salivary drug analytes, including both drugs of abuse and therapeutic drugs, include opiates, which includes but is not limited to methadone, morphine, 6-monoacetytl morphine, heroin, dextromethorphen, meperidine, codeine, cocaine, hydromorphone, pholcodine, and metabolites thereof.

Additional salivary drug analytes, including both drugs of abuse and therapeutic drugs, is the barbiturates, such as barbital, amobarbital, hexobarbital, Phenobarbital, methyl phenobarbital, phencyclidine (PCP), pentobarbital.

Additional salivary drug analytes, including both drugs of abuse and therapeutic drugs, includes those derived from marijuana, which includes cannabinol, tetrahydrocannabinol, 11-nor-9-carboxy-delta-9-tetrahydrocannabinol (THC).

More specific examples of salivary drug analytes, including both drugs of abuse and therapeutic drugs, include benzodiazepines including alprazolam, bretazenil, bromazepam, chlorodiazepoxide, cinolazepam, clonazepam, cloxazolam, clorazepate, diazepam, estazolam, fludiazepam, flunirazepam, flurazepam, flutoprazepam, halazepam, ketazolam, loprazolam, lorazepam, lormetazepam, medazepam, midazolam, nimetazepam, nitrazepam, nordiazepam, N-Desmethyldiazepam, oxazepam, phenazepam, pinazepam, prazepam, premazepam, quazepam, temazepam, tetrazepam, triazolam, and other benzodiazepine receptor ligands such as clobazam, DMCM, flumazenil, eszopiclone, zaleplon, zolpidem, and zopiclone. Examples of phenothiazines include chlorpromazine, promethazine, triflupromazine, methotrimeprazine, mesoridazine, thioridazine, fluphenazine, perphenazine, prochlorperazine, and trifluoperazine.

Other individual miscellaneous salivary drug analytes, including both drugs of abuse and therapeutic drugs, include nicotine and cotinine.

Specific examples of salivary analytes used for detecting cancer include mRNA biomarkers for pancreatic cancer, mRNA markers for oral cancer, HER2/neu, CA 15-3, p53, transferrin, cyclin D1, and maspin (serpin B5).

Specific examples of salivary analytes used for detecting certain metabolic disorders include glucose, anti-HIV antibody, HBV surface antigen, anti-HAV (IgM and IgG), anti-Helicobacter pylori (anti-H. pylori IgG), allergen-specific IgA, chromogranin A, lysozyme, peroxidase, hydroxyproline, calcium, and C-reactive protein.

Specific examples of salivary analytes used for detecting hormones include cortisol, alpha amylase, estradiol, progesterone, dehydroepiandrosterone (DHEA), testerosterone, leutinizing hormone, melatonin, and cyclin D.

Specific examples of salivary analytes used for detecting and investigating human psychological phenomenon are cortisol and alpha amylase.

### Samples

An analyte of interest may be present in a wide variety of environments, and it is envisioned that a person having ordinary skill in the art will readily understand that the components and embodiments discussed above can be modified as needed to accommodate different environments of samples.

Analytes of interest may be found in a patient's physiological fluids, such as mucus, blood, serum, blood plasma, lymph, puss, urine, feces, cerebral spinal fluid, ocular lens liquid, ascites, semen, sputum, saliva, sweat, and secreted oils. Samples for testing analytes may be obtained using techniques known or envisioned to provide samples of such physiological fluids. Optionally, analytes may be detected by directly contacting embodiments of the diagnostic test strips with the patient's body, such as their skin, eyes, mouth cavity regions including the tongue, tonsils, and inner lining of the mouth and throat, and the nasal cavity. Alternatively, some analytes may be detected by directly contacting embodiments of the diagnostic test strips with a patient's urine stream, source of bleeding, source of puss, discharge from sex organs, or other site of fluid leakage from the patient.

Analytes may also be found in synthetic chemicals, water, soil, air and food (e.g., milk, meat, poultry, or fish). Any organic- and inorganic-containing substances can serve as an analyte so long as test reagents are available to generate a signal concerning the presence, absence, and/or concentration of the analyte.

For oral fluids such as saliva, samples may be obtained by contacting an embodiment with a patient's tongue such that the tongue contacts the one or more test pads. Alternatively, salivary samples may be obtained by contacting an embodiment with the top and/or sides of a patient's tongue using a substantially back and forth motion from substantially the tip of the tongue to substantially the back of the tongue. Furthermore, salivary samples may be obtained by contacting an embodiment with the top and/or sides of a patient's tongue using a substantially side-to-side motion along the width of the tongue. Similarly, salivary samples may also be obtained by contacting an embodiment with the top and/or sides of a patient's tongue using a substantially circular motion. For each of the above described sample collection methods, the results of the analysis could then be read directly from the diagnostic test strip by a user. Optionally, test results could be stored to a suitable memory device for recordation and later access.

Prior to use with embodiments of the invention, samples may be preserved, stored, or pre-treated in manners consistent with known handling of the same, or similar, types of samples. It is envisioned that any type of preservation, storage, or pre-treatment may be utilized so long as it does not introduce false positives or false negatives into the assay.

### CONCLUSION

While the invention has been described with reference to the specific embodiments thereof, it should be understood by those skilled in the art that various changes may be made and equivalents may be substituted without departing from the true spirit and scope of the invention. For example, some embodiments do not provide all of the benefits and features set forth herein. In addition, many modifications may be made to adapt a particular situation, material, composition of matter, process, process step or steps, to the objective, spirit and scope of the present invention. Furthermore, practiced embodiments may include features of more than one of the described embodiments. All such modifications are intended to be within the scope of the claims appended hereto. Accordingly, the scope of the invention is defined only by reference to the appended claims.

What is claimed is:

1. A system for maintaining the reagent integrity of a diagnostic test device, wherein the system is comprised of:
a) a diagnostic test device comprising one or more test pads, wherein at least one test pad has at least one test reagent thereon;
b) an upper flexible sheet;
c) a lower flexible sheet; and
d) a flexible supporting sheet;
wherein the upper and lower sheets are joined to form an hermetically sealed cavity and further wherein the flexible supporting sheet is inside the cavity and attached to a joint formed by the upper and lower flexible sheets, and wherein the supporting sheet substantially bisects the cavity, further wherein the cavity is at least partially inflated with one or more gases creating an inner wall, and wherein the diagnostic test device is removably in contact with the support sheet and the inner walls of the inflated cavity do not contact the diagnostic test device.

2. The system of claim 1, wherein the upper flexible sheet, the lower flexible sheet, and the flexible supporting sheet are made of different material.

3. The system of claim 1, wherein the upper flexible sheet, the lower flexible sheet, and the flexible supporting sheet are made of the same material.

4. The system of claim 1, wherein the upper flexible sheet and the lower flexible sheet are opaque.

5. The system of claim 1, wherein the upper flexible sheet and the lower flexible sheet are metal foil.

6. The system of claim 4, wherein the upper flexible sheet and the lower flexible sheet are surgical aluminum foil.

7. The system of claim 4, wherein the upper flexible sheet and the lower flexible sheet are medical aluminum foil.

8. The system of claim 1, wherein the upper flexible sheet and the lower flexible sheet are plastic.

9. The system of claim 1, wherein the gas used to at least partially inflate the cavity is an inert gas.

10. The system of claim 8, wherein the gas is nitrogen.

11. The system of claim 8, wherein the gas is argon.

12. The system of claim 1, wherein the gas used to at least partially inflate the cavity is medical air.

13. The system of claim 1, wherein the gas used to at least partially inflate the cavity is ambient air.

14. The system of claim 1, wherein the gas used to at least partially inflate the cavity is carbon dioxide.

15. The system of claim 1, wherein the one or more gases substantially fully inflates the cavity.

16. The system of claim 1, wherein the joint formed with the upper flexible sheet, the lower flexible sheet, and the supporting sheet is formed with ultrasound welding.

17. The system of claim 1, wherein the joint formed with the upper flexible sheet, the lower flexible sheet, and the supporting sheet is formed with adhesives.

18. The system of claim 1, wherein the joint formed with the upper flexible sheet, the lower flexible sheet, and the supporting sheet is formed by resistive welding.

19. The system of claim 1, wherein the diagnostic test device is attached to the flexible supporting sheet with low tack adhesive.

20. The system of claim 1, wherein the diagnostic test device is attached to the flexible supporting sheet with low tack adhesive.

21. The system of claim 1, wherein the diagnostic test device is attached to the flexible supporting sheet with a mechanical retaining device that is in turn attached to the flexible supporting sheet.

22. A system for maintaining the reagent integrity of a diagnostic test device, wherein the system is comprised of:
a) a diagnostic test device, further wherein the test device has one or more test pads wherein at least one test pad has at least one test reagent thereon;
b) an outer top flexible sheet;
c) an outer bottom flexible sheet;
d) an inner top flexible sheet;
e) an inner bottom flexible sheet; and
d) a flexible supporting sheet;
wherein the inner top and inner bottom sheets are joined to form an hermetically sealed inner cavity with one or more outer edges and further wherein the supporting flexible sheet is encapsulated by the inner cavity and attached to a joint formed by the inner top flexible sheet and the inner bottom flexible sheet, and wherein the supporting sheet substantially bisects the inner cavity, further wherein the outer top and outer bottom sheets are joined together with a joint where the joint can be the same joint that is formed by the inner top sheet and the inner bottom sheet or the joint can be a second joint formed by the outer top sheet and the outer bottom sheet, further wherein the outer top and bottom sheets are joined together with the edges of the inner cavity forming an outer cavity that contains the inner cavity, and wherein the outer cavity is at least partially inflated with one or more gases, and the atmosphere of the inner cavity may be substantially a vacuum or the cavity is at least partially inflated with one or more gases and wherein the diagnostic test device is removably in contact with the support sheet.

23. The system of claim 22, wherein the inner walls of the inflated inner cavity do not contact the diagnostic test device.

24. The system of claim 22, wherein the inner walls of the inflated inner cavity do contact the diagnostic test device.

25. The system of claim 22, wherein all of the flexible sheets are made of the same material.

26. The system of claim 22, wherein some or all of the flexible sheets are made of the different material.

27. The system of claim 22, wherein the outer top flexible sheet and the outer bottom flexible sheet are opaque.

28. The system of claim 22, wherein the outer top flexible sheet and the outer bottom flexible sheet are metal foil.

29. The system of claim 28, wherein the outer top flexible sheet and the outer bottom flexible sheet are surgical aluminum foil.

30. The system of claim 28, wherein the outer top flexible sheet and the outer bottom flexible sheet are medical aluminum foil.

31. The system of claim 22, wherein the outer top flexible sheet and the outer bottom flexible sheet are plastic.

32. The system of claim 22, wherein both the inner cavity and the outer cavity are partially filled with a gas.

33. The system of claim 32, wherein the gas is an inert gas.

34. The system of claim 22, wherein the outer cavity is at least partially filled with a gas and the inner cavity has at least a partial vacuum as an atmosphere.

35. The system of claim 34, wherein the gas is an inert gas.

36. The system of claim 22, wherein the gas in both the inner cavity and the outer cavity is an inert gas.

37. The system of claim 36, wherein the gas in each of the two cavities is the same.

38. The system of claim 36, wherein the gas is nitrogen.

39. The system of claim 36, wherein the gas is argon.

40. The system of claim 36, wherein the gas is ambient air.

41. The system of claim 36, wherein the gas is medical air.

42. The system of claim 36, wherein the gas is carbon dioxide.

43. The system of claim 22, wherein the outer cavity is substantially fully inflated.

44. The system, of claim 22, wherein both the inner and outer cavities are substantially fully inflated.

45. The system of claim 22, wherein the outer cavity is substantially fully inflated and the atmosphere of the inner cavity is substantially a vacuum.

46. The system of claim 22, wherein the outer cavity is substantially fully inflated and the inner cavity is partially inflated.

47. The system of claim 22, wherein the joints forming both cavities are formed by the same method.

48. The system of claim 47, wherein the joints are formed by ultrasound welding.

49. The system of claim 47, wherein the joints are formed by resistive welding.

50. The system of claim 47, wherein the joints are formed with adhesives.

51. The system of claim 22, wherein the diagnostic test device is attached to the flexible supporting sheet with low tack adhesive.

52. The system of claim 22, wherein the diagnostic test device is attached to the flexible supporting sheet with a mechanical retaining device that in turn is attached to the flexible supporting sheet.

53. The system of claim 22, further comprising a third top flexible sheet and third bottom flexible sheet, wherein the third top and bottom sheets are attached to the joint formed by the inside and outside flexible sheets and further forms a third cavity, wherein said cavity encapsulates the inner and outer cavities.

54. The system of claim 53, wherein the material of all of the flexible sheets is the same.

55. The system of claim 53, wherein the material for all of the flexible sheets is different.

56. The system of claim 53, wherein the material for the third top and bottom flexible sheets is opaque.

57. The system of claim 53, wherein third cavity is at least partially inflated with a gas.

58. The system of claim 53, wherein the third cavity is substantially inflated with a gas.

59. The system of claim 53, wherein the atmosphere in the third cavity is substantially a vacuum.

60. The system of claim 53, wherein one or more gases are used to pressurize the third cavity.

61. The system of claim 60, wherein the gas is nitrogen.

62. The system of claim 60, wherein the gas is argon.

63. The system of claim 60, wherein the gas is ambient air.

64. The system of claim 60, wherein the gas is medical air.

65. The system of claim 60, wherein the gas is carbon dioxide.

66. A system for maintaining the integrity of the reagents on a diagnostic test device, comprising:
a) A bottom member that is substantially rigid tub-shaped container with an opening,
b) a top substantially flexible sealing member,
c) a diagnostic test device, and
d) one or more pressurized gases;
wherein the sealing member is removably attached to the bottom member such that it forms a hermetically sealed cavity, and the cavity contains the diagnostic test device and the one or more pressurized gases.

67. The system of claim 66, wherein the bottom member is made of plastic.

68. The system of claim 66, wherein the sealing member is a metallic foil.

69. The system of claim 66, wherein the sealing member is attached to the bottom member by ultrasonic welding.

70. The system of claim 66, wherein the sealing member is attached to the bottom member by resistive welding.

71. The system of claim 66, wherein the sealing member is attached to the bottom member by adhesives.

72. The system of claim 66, wherein further the diagnostic test device is removably mechanically attached to the bottom member such that the reagents on the test device do not come in contact with the inner surfaces of the cavity.

73. The system of claim 66, wherein the gas is nitrogen.

74. The system of claim 66, wherein the gas is argon.

75. The system of claim 66, wherein the gas is medical air.

76. The system of claim 66, wherein the gas is carbon dioxide.

77. The system of claim 66, wherein the gas is ambient air.
